(19) United States
(12) Patent Application Publication
(10) Pub. No.: US 2026/0018771 A1
(43) Pub. Date: Jan. 15, 2026

(54) MULTIBAND FILTER AND COMMUNICATION DEVICE

(71) Applicant: Telefonaktiebolaget LM Ericsson (publ), Stockholm (SE)

(72) Inventors: Yuhua XIAO, Beijing (CN); Juandi SONG, Beijing (CN)

(21) Appl. No.: 18/881,343

(22) PCT Filed: Aug. 25, 2022
(86) PCT No.: PCT/CN2022/114885

§ 371 Date: Jan. 6, 2025

(51) Int. Cl. H01P 1/20; H01P 3/08; H01P 7/08

(52) U.S. Cl. CPC H01P 1/20; H01P 3/08; H01P 7/08

(57) ABSTRACT

The present invention relates to a multiband filter and a communication device. The multiband filter includes a plurality of multimode resonators, wherein each of the multimode resonators is a strip line resonator including a grounding part and two or more non-grounding branches for achieving multiple modes.

### TECHNICAL FIELD

The present disclosure generally relates to components of communication device, and more particularly, to a multiband filter and a communication device having the multiband filter.

### BACKGROUND

This section introduces aspects that may facilitate better understanding of the present disclosure. Accordingly, the statements of this section are to be read in this light and are not to be understood as admissions about what is in the prior art or what is not in the prior art.

Base station (BS) is an important part of a mobile communication system, and may include a radio unit (RU) and an antenna unit (AU). Considering the installation/fixation/occupation, smaller volume and lighter weight is always an important evolution direction in BS design, including legacy base station, street macro, micro, small cell and advanced antenna system (AAS).

With the development of 5th Generation (5G) communication, Multiple-Input and Multiple-Output (MIMO) technology is widely used in Sub-6 GHZ BS product, in which a large number of filters need to be integrated/embedded with AU or RU. There are many kinds of filter solutions that can be applied to BS, such as ceramic waveguide (CWG) filters, coaxial metal cavity filters, Monoblock filters, bulk acoustic wave (BAW) filters, surface acoustic wave (SAW) filters, etc.

To get size/weight and cost benefit, especially a good performance, small size metal filter is an irreplaceable solution. It can be soldered onto radio mother board (MOB), antenna calibration (AC) board or power splitter board, which will reduce the radio size and weight. It also can be connected by connectors with other radio components, same as macro station.

To further reduce the radio size and weight based on small size metal filter technology, it is a new popular way to integrate two different passbands or multiple passbands to one radio. The different bands of time divisional duplex (TDD) radio could work together, which will transmit and receive more signals at different time zone. For coming 5G frequency division duplex (FDD) system, a proper duplexer is also important to reduce radio size. The different bands of FDD radio also could work together, some bands for signal receiving and other bands for signal transmitting.

The exists scheme of small size metal filters usually use metal integration air-strip line resonator to reduce size/weight compared with traditional coaxial resonator. The traditional multiband and FDD FU always combine two or more filters of different frequency bands by a common cavity to get one duplexer or multiplexer. However, when two or more filters are combined, the FU may become big and heavy, and the FU is hard to be soldered onto a printed circuit board (PCB).

Thus, it is important to find a better way to combine two or more different frequency bands into one unit.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide a small size multiband filter, which can further reduce radio size/weight and cost.

According to a first aspect of the disclosure, there is provided a multiband filter comprising a plurality of multimode resonators, wherein each of the multimode resonators is a strip line resonator comprising a grounding part and two or more non-grounding branches for achieving multiple modes.

In an embodiment of the disclosure, the multiband filter further comprises a chassis that defines a cavity, wherein the multimode resonators are disposed in the cavity, and the grounding part is connected to the chassis.

In an embodiment of the disclosure, the multimode resonators are produced integrally with the chassis.

In another embodiment of the disclosure, the multimode resonators are produced separately with the chassis and are connected to the chassis by soldering or welding.

In an embodiment of the disclosure, the chassis and/or the strip line resonator is/are made of metal or a non-metal base with a metallized surface.

In another embodiment of the disclosure, the multiband filter further comprises a multi-layer circuit board, whererin the multimode resonators are arranged on a middle layer that is sandwiched between an upper conductive layer and a lower conductive layer, and are surrounded by metalized vias for electrically connecting the upper conductive layer and the lower conductive layer.

In an embodiment of the disclosure, the grounding part of each of the multimode resonators is connected to one of the metalized vias.

In an embodiment of the disclosure, the middle layer is made of ceramic, and the multimode resonators are formed on the middle layer by Low Temperature Co-fired Ceramic (LTCC) technology or High Temperature Co-fired Ceramic (HTCC) technology.

In an embodiment of the disclosure, the multi-layer circuit board is a Printed Circuit Board Assembly (PCBA), and the multimode resonators are laminated on the middle layer.

In an embodiment of the disclosure, at least one multimode resonator is formed across two or more layers, and portions of the at least one multimode resonator on different layers are connected by metalized via(s) through the layers.

In an embodiment of the disclosure, one of the plurality of multimode resonators is connected to a first radio frequency (RF) port, and another one of the plurality of multimode resonators is connected to a second RF port.

In another embodiment of the disclosure, one of the plurality of multimode resonators is connected to a first RF port, and another one of the plurality of multimode resonators is coupled to multiple single mode resonators, each single mode resonator being connected to a corresponding one of multiple second RF ports.

In an embodiment of the disclosure, the multiband filter can be tuned in production by a tuning screw or a tuning tab.

In an embodiment of the disclosure, the frequency and/or the coupling in different modes can be tuned separately.

In an embodiment of the disclosure, the non-grounding branches of the strip line resonator substantially extend in the same plane.

In an embodiment of the disclosure, at least one of the non-grounding branches can be folded and/or can be provided with an enlarged end portion.

In an embodiment of the disclosure, at least one of the non-grounding branches can be formed with a hole or a recess.

In an embodiment of the disclosure, at least two non-grounding branches of the strip line resonator extend substantially parallel to each other and have different lengths in the extending direction.

In an embodiment of the disclosure, the grounding part of the strip line resonator is provided at a junction of the two or more non-grounding branches.

In an embodiment of the disclosure, plastic material is added on at least one side of the strip line resonator.

In an embodiment of the disclosure, a metal strip line low pass filter (LPF) is provided at an input area or an output area of the multiband filter.

According to a second aspect of the disclosure, there is provided a communication device, which comprises at least one multiband filter according to the first aspect.

In an embodiment of the disclosure, the multiband filter is soldered on a radio board or an antenna board, or is connected to the radio board or the antenna board by an RF connector.

### BRIEF DESCRIPTION OF THE DRAWINGS

These and other objects, features and advantages of the disclosure will become apparent from the following detailed description of illustrative embodiments thereof, which are to be read in connection with the accompanying drawings, in which

FIG. 1A shows a dual mode resonator in a dual band filter according to a first embodiment of the disclosure, FIG. 1B shows electric and magnetic fields in the first mode, and FIG. 1C shows electric and magnetic fields in the second mode;

FIG. 2A is a perspective view of the dual band filter according to the first embodiment, and FIG. 2B is a front view of the dual band filter;

FIG. 3 is a schematic diagram illustrating a topology of the dual band filter according to the first embodiment;

FIG. 4A and FIG. 4B each show a simulation frequency response curve of the dual band filter according to the first embodiment;

FIG. 5 is a perspective view of a dual band filter according to a second embodiment of the disclosure;

FIG. 6A is a perspective view of a dual band filter according to a third embodiment of the disclosure, and FIG. 6B is a schematic diagram illustrating a topology of the dual band filter according to the third embodiment;

FIGS. 7A-7H show different variants of a dual mode resonator according to the disclosure;

FIG. 8A shows a triple mode resonator in a triple band filter according to a fourth embodiment of the disclosure, FIG. 8B shows electric and magnetic fields in the first mode, FIG. 8C shows electric and magnetic fields in the second mode, and FIG. 8D shows electric and magnetic fields in the third mode;

FIGS. 9A-9D show different variants of a triple mode resonator according to the disclosure;

FIG. 10A shows a quadruple mode resonator in a quadruple band filter according to a fifth embodiment of the disclosure, FIG. 10B shows electric and magnetic fields in the first mode, FIG. 10C shows electric and magnetic fields in the second mode, FIG. 10D shows electric and magnetic fields in the third mode, and FIG. 10E shows electric and magnetic fields in the fourth mode;

FIG. 11A and FIG. 11B show different variants of a quadruple mode resonator according to the disclosure; and.

FIG. 12A and FIG. 12B show another kind of multiband filter according to the disclosure

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

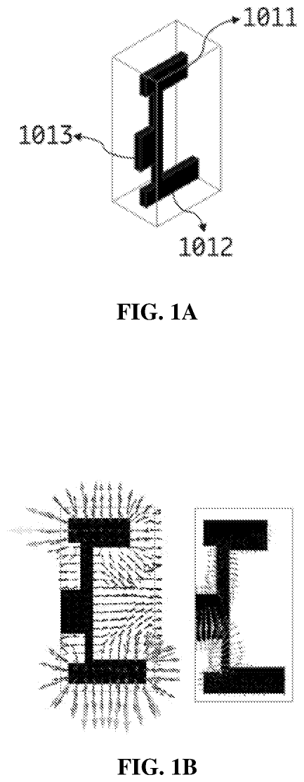

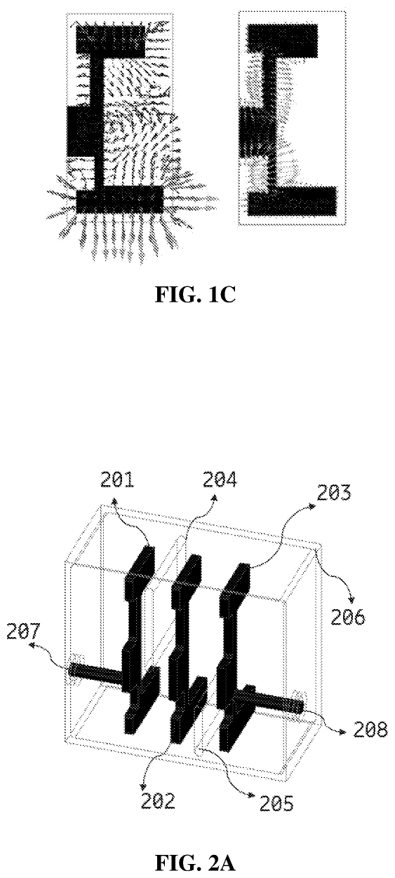

FIG. 1A shows a dual mode resonator in a dual band filter according to a first embodiment of the disclosure. As shown in FIG. 1A, the dual mode resonator is disposed in a cavity defined by a chassis. As an example, the chassis may be made of metal, such as aluminum, through an extrusion molding process. The chassis can also be made of a non-metal base with a metallized surface. The dual mode resonator is a strip line resonator which may also be made of metal or a non-metal base with a metallized surface. The material of the dual mode resonator can be the same as or different from the material of the chassis. The dual mode resonator comprises two non-grounding branches 1011, 1012 and a grounding part 1013. The grounding part 1013 is provided at a junction of the two non-grounding branches 1011, 1012, and is connected to the chassis by soldering or welding.

In this embodiment, the grounding part 1013 and the two non-grounding branches 1011, 1012 extend in the same plane. The dual mode resonator may be punched out from a metal sheet and has a uniform thickness. However, the present disclosure is not limited to this, and the grounding part 1013 as well as the two non-grounding branches 1011, 1012 may have different thicknesses. Each of the two non-grounding branches 1011, 1012 has a connection portion connected to the grounding part 1013 and a main body portion perpendicular to the connection portion. The main body portion of the non-grounding branch 1011 is parallel to the main body portion of the non-grounding branch 1012. In this connection, it can be said that the two non-grounding branches 1011, 1012 extend substantially parallel to each other. Preferably, the main body portions of the two non-grounding branches 1011, 1012 have different lengths in the extending direction. The width of the main body portion of one grounding branch 1011 in a direction perpendicular to the extending direction and the thickness direction may be the same as or different from the width of the main body portion of the other grounding branch 1012, and is greater than the width of the connection portion of the non-grounding branches 1011, 1012.

FIG. 1B shows an electric field (left) and a magnetic field (right) of the dual mode resonator in the first mode, and FIG. 1C shows an electric field (left) and a magnetic field (right) of the dual mode resonator in the second mode. In this embodiment, the first mode is achieved by the whole resonator, and the second mode is achieved by the half bottom side of the resonator. The frequency and/or the coupling in the first mode can be tuned at the top side of the resonator. The frequency and/or the coupling in the second mode can be tuned at the bottom side of the resonator. For example, the tuning can be performed by means of a tuning screw or a tuning tab.

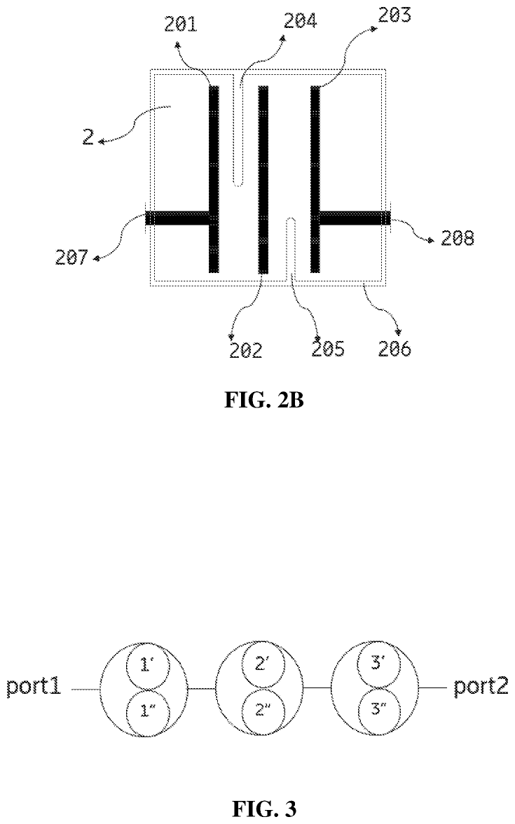

FIG. 2A is a perspective view of the dual band filter according to the first embodiment, and FIG. 2B is a front view of the dual band filter. The dual band filter 2 in this embodiment is a three-pole filter and has three dual mode resonators 201, 202, 203. Each of the three dual mode resonators 201, 202, 203 is configured as shown in FIG. 1A. An isolation wall 204 is provided between the dual mode resonator 201 and the dual mode resonator 202, and another isolation wall 205 is provided between the dual mode resonator 202 and the dual mode resonator 203. The isolation walls 204, 205 can control the coupling between adjacent resonators. The isolation walls 204, 205 and the grounding parts of the three dual mode resonators 201, 202, 203 are connected to a chassis 206, which may be made of same or different material with the resonators. The material may be metal or a non-metal base with a metallized surface.

The dual band filter 2 is provided with two RF ports 207, 208 on two opposite sides of the chassis 206. The dual mode resonator 201 is connected to a first RF port 207, and the dual mode resonator 203 is connected to a second RF port 208. The location of the two RF ports 207, 208 can be adjusted according to actual requirements. The dual band filter 2 may be connected to other radio components through RF connectors provided at the two RF ports 207, 208. In other embodiments, the RF connectors may be dispensed with, and the dual band filter can be soldered on a radio board or an antenna board directly by a solder pad.

To further reduce the filter size, a plastic material can be added on the top and/or bottom side of each of the dual mode resonators 201, 202, 203. The plastic material will bring higher dielectric constant compared with air in the cavity defined by the chassis 206.

FIG. 3 is a schematic diagram illustrating a topology of the dual band filter 2 shown in FIG. 2A and FIG. 2B. As described with respect to FIGS. 1A-1C, each of the three dual mode resonators 201, 202, 203 has two different modes. Mode 1′, 2′, 3′ (the first mode) of the three dual mode resonators 201, 202, 203 couple to achieve the first frequency band of the dual band filter 2, and Mode 1″, 2″, 3″ (the second mode) of the three dual mode resonators 201, 202, 203 couple to achieve the second frequency band of the dual band filter 2. The port1 in FIG. 3 corresponds to the RF port 207 in FIGS. 2A and 2B, and the port2 in FIG. 3 corresponds to the RF port 208 in FIGS. 2A and 2B.

It will be understood that more dual mode resonators may be added to get a more pole dual band filter.

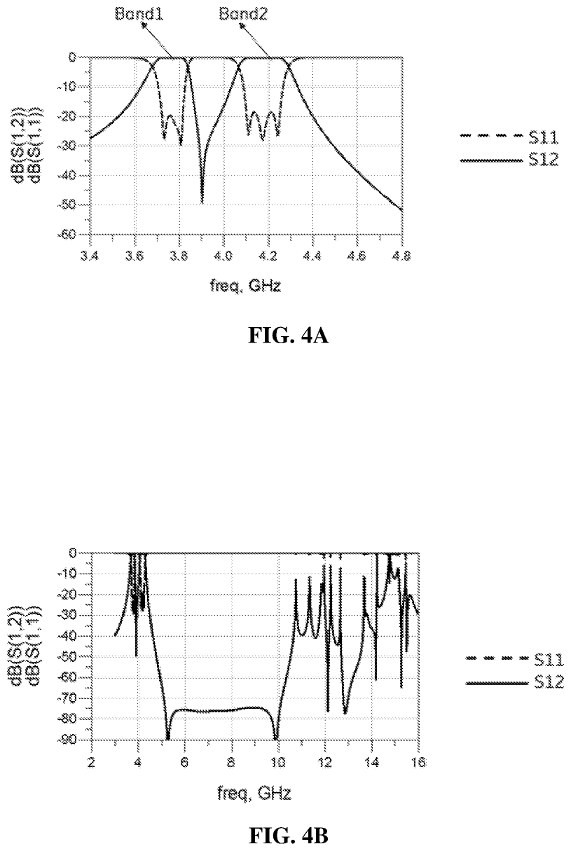

FIG. 4A shows a simulation frequency response curve of the dual band filter according to the first embodiment. Band1 (the first frequency band) is a lower frequency band achieved by Mode 1′, 2′, 3′ (the first mode) of the three dual mode resonators 201, 202, 203, and Band2 (the second frequency band) is a higher frequency band achieved by Mode 1″, 2″, 3″ (the second mode) of the three dual mode resonators 201, 202, 203.

FIG. 4B shows the far end harmonic, which is about three times of the lower frequency modes of the dual band filter. To get better far end attenuation, a metal strip line LPF may be provided at an input area or an output area of the dual band filter.

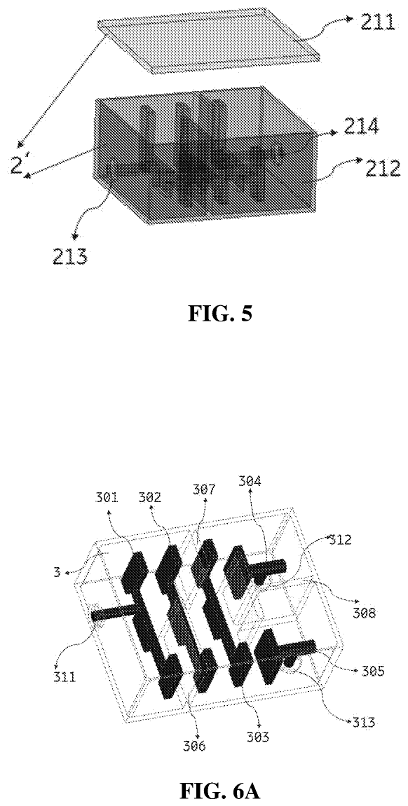

FIG. 5 is a perspective view of a dual band filter 2′ according to a second embodiment of the disclosure. The second embodiment differs from the above first embodiment in that the three dual mode resonators are produced one time and integrally with the chassis to form a main part 212, which is then connected by soldering or welding with a cover 211 that is produced separately. Two RF ports 213, 214 are provided at two opposite sides of the main part 212.

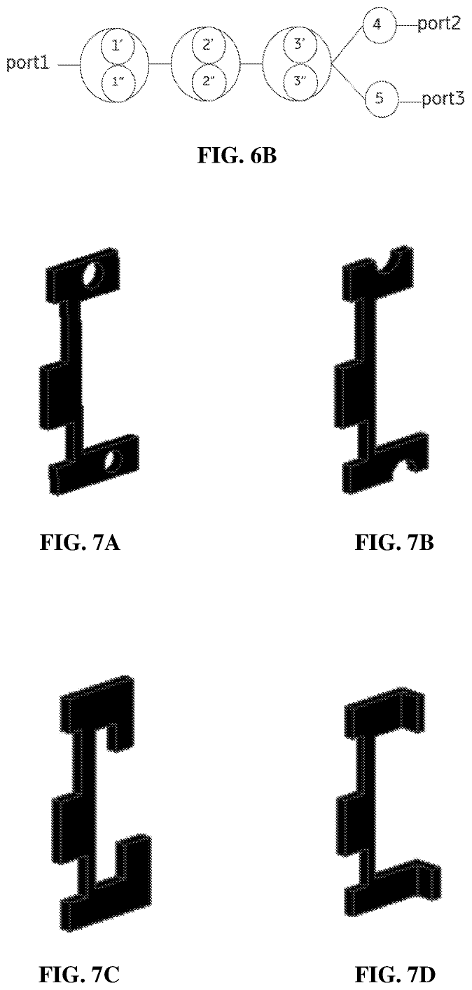

FIG. 6A is a perspective view of a dual band filter according to a third embodiment of the disclosure. Like the dual band filter in the first or second embodiment, the dual band filter 3 in the third embodiment also has three dual mode resonators 301, 302, 303 and two isolation walls 306, 307. The third embodiment differs from the first embodiment mainly in that two single mode resonators 304, 305 are provided adjacent to the two mode resonator 303 and are coupled to the two mode resonator 303. An isolation wall 308 is provided between the two mode resonator 303, the single mode resonator 304 and the single mode resonator 305, so as to isolate the two single mode resonators 304, 305 and control the coupling between the two single mode resonators 304, 305 and the two mode resonator 303. The two mode resonator 301 is connected to a first RF port 311. The single mode resonator 304 is connected to a second RF port 312. The single mode resonator 305 is connected to a third RF port 313. Thus, the dual band filter 3 in the third embodiment can be connected at the second and third RF ports 312, 313 with two single band components which cannot achieve dual band FU.

FIG. 6B is a schematic diagram illustrating a topology of the dual band filter according to the third embodiment. The port1 in FIG. 6B corresponds to the RF port 311 in FIG. 6A, the port2 in FIG. 6B corresponds to the RF port 312 in FIG. 6A, and the port3 in FIG. 6B corresponds to the RF port 313 in FIG. 6A.

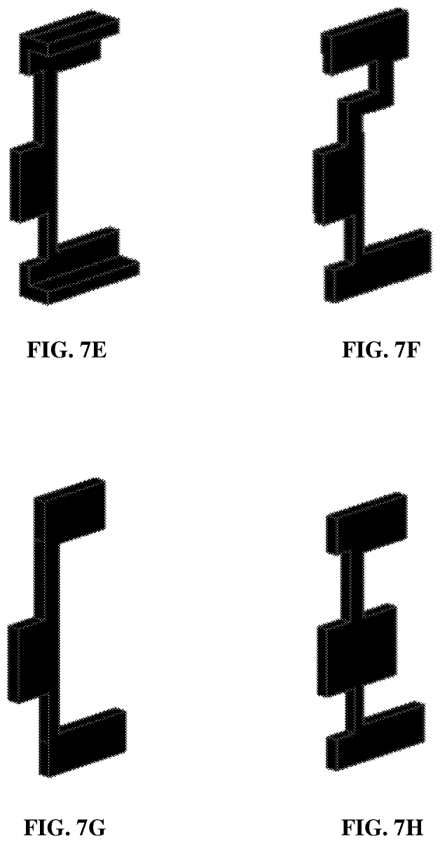

FIGS. 7A-7H show different variants of a dual mode resonator according to the disclosure.

The dual mode resonator shown in FIG. 7A differs from the dual mode resonator shown in FIG. 1A in that two holes are provided at the main body portions of the two non-grounding branches. The dual mode resonator shown in FIG. 7B differs from the dual mode resonator shown in FIG. 1A in that two recesses are provided at the main body portions of the two non-grounding branches. Other parts or portions are the same as those in FIG. 1A, and detailed description thereof will not be repeated. This applies to each of FIGS. 7C-7H.

The dual mode resonators shown in FIGS. 7C-7E differ from the dual mode resonator shown in FIG. 1A in that the main body portion of each of the two non-grounding branches is folded toward different directions. The dual mode resonator shown in FIG. 7F differs from the dual mode resonator shown in FIG. 1A in that the non-grounding branch on the upper side is folded at the connection portion thereof. It will be understood by those skilled in the art that the main body portion of the dual mode resonators shown in FIGS. 7C-7E can be folded toward an opposite direction, and the non-grounding branch on the lower side in FIG. 7F can also be folded at the connection portion thereof.

The dual mode resonator shown in FIG. 7G differs from the dual mode resonator shown in FIG. 1A in that the main body portion of each of the two non-grounding branches does not extend toward the side of the grounding part.

With regarding to the variants shown in FIGS. 7A-7G, it will be understood by those skilled in the art that increasement of area of the non-grounding branches will lower the frequency of the corresponding mode, and reduction of area of the non-grounding branches can tune the frequency in the increment direction.

The dual mode resonator shown in FIG. 7H differs from the dual mode resonator shown in FIG. 1A in that there is a further substantially mirrored part of the grounding part with respect to the connecting portion of the two non-grounding branches. The substantially mirrored part is provided to tune the harmonic, and may have an area that is equal to, larger than or smaller than the area of the grounding part.

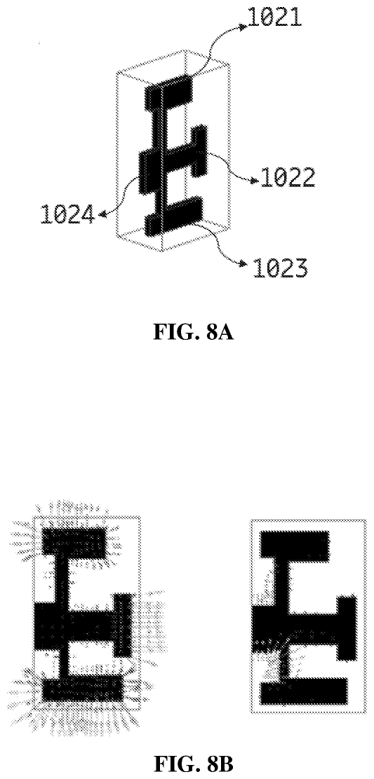

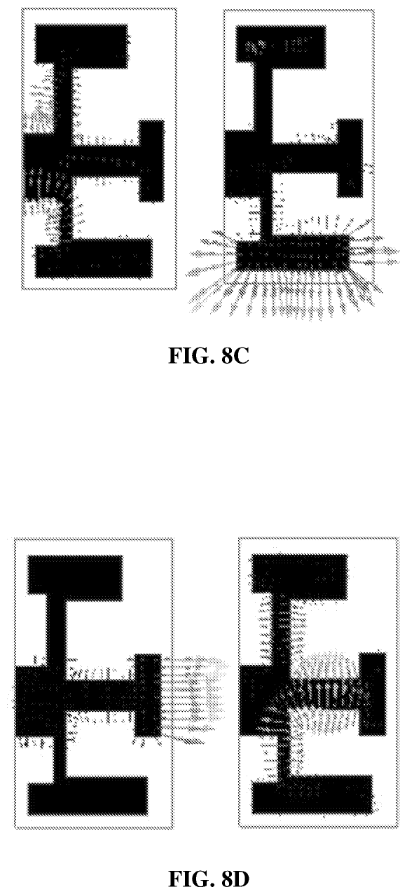

FIG. 8A shows a triple mode resonator in a triple band filter according to a fourth embodiment of the disclosure. As shown in FIG. 8A, the triple mode resonator is disposed in a cavity defined by a chassis, which may be made of metal or a non-metal base with a metallized surface. The triple mode resonator is a strip line resonator which may also be made of metal or a non-metal base with a metallized surface. The material of the triple mode resonator can be the same as or different from the material of the chassis. The triple mode resonator comprises three non-grounding branches 1021, 1022, 1023 and a grounding part 1024. The grounding part 1024 is provided at a junction of the three non-grounding branches 1021, 1022, 1023, and is connected to the chassis by soldering or welding.

In this embodiment, the grounding part 1024 and the three non-grounding branches 1021, 1022, 1023 extend in the same plane. The triple mode resonator may be punched out from a metal sheet and has a uniform thickness. However, the present disclosure is not limited to this, and the grounding part 1024 as well as the three non-grounding branches 1021, 1022, 1023 may have different thicknesses. In this embodiment, the middle non-grounding branch 1022 has a T-shaped cross section, comprising a horizontal main body portion and a vertical tip portion. Each of the non-grounding branches 1021, 1023 has a connection portion connected to the grounding part 1024 and a main body portion perpendicular to the connection portion. The main body portion of the non-grounding branch 1021 and the main body portion of the non-grounding branch 1023 both extend in the horizontal direction, and thus are parallel to the main body portion of the non-grounding branch 1022. In this connection, it can be said that the three non-grounding branches 1021, 1022, 1023 extend substantially parallel to each other. Preferably, the main body portions of the three non-grounding branches 1021, 1022, 1023 have different lengths in the horizontal direction. Also, the width of the main body portions of the three non-grounding branches 1021, 1022, 1023 may be the same as or different from each other, and is greater than the width of the connection portion of the non-grounding branches 1021, 1023 and the tip portion of non-grounding branch 1022.

FIG. 8B shows an electric field (left) and a magnetic field (right) of the triple mode resonator in the first mode, FIG. 8C shows an electric field (left) and a magnetic field (right) of the triple mode resonator in the second mode, and FIG. 8D shows an electric field (left) and a magnetic field (right) of the triple mode resonator in the third mode. In this embodiment, the first mode is achieved by the whole resonator, the second mode is achieved by the half bottom side of the resonator, and the third mode is achieved by the middle portion of the resonator. The frequency and/or the coupling in the three modes can be tuned separately at the top side, the bottom side, and the middle portion of the resonator. For example, the tuning can be performed by means of a tuning screw or a tuning tab.

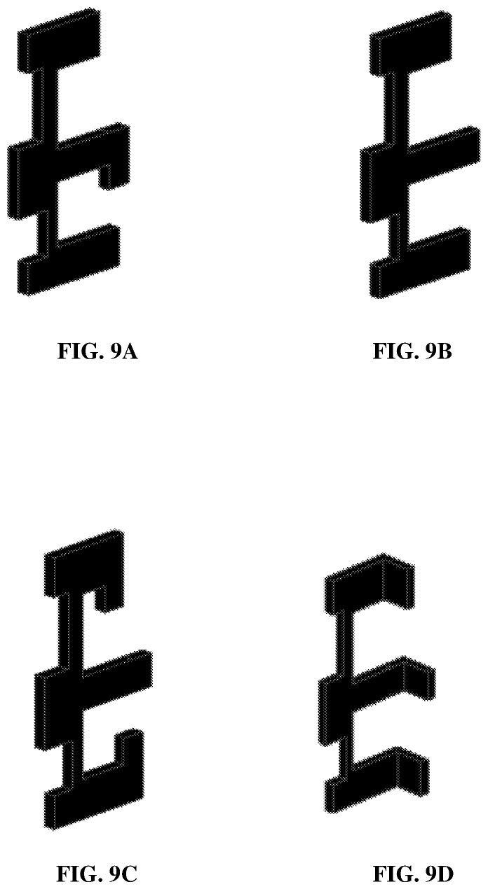

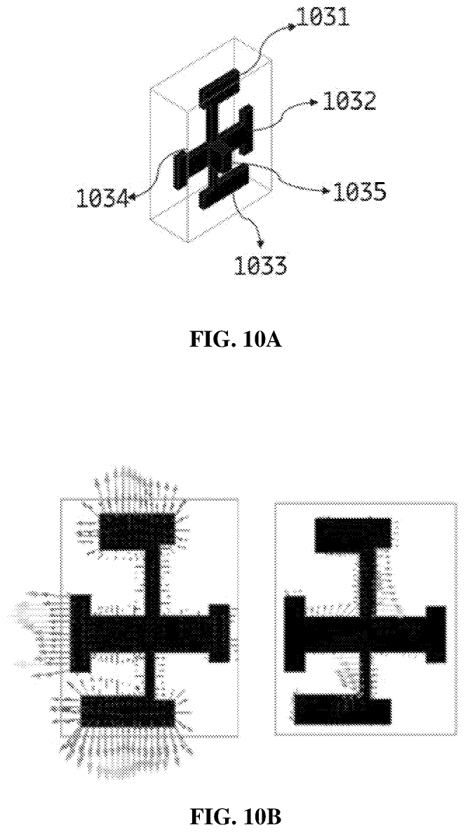

FIGS. 9A-9D show different variants of a triple mode resonator according to the disclosure.

The triple mode resonator shown in FIG. 9A differs from the triple mode resonator shown in FIG. 8A in that the T-shaped non-grounding branch 1022 in FIG. 8A is replaced with an L-shaped non-grounding branch.

The triple mode resonator shown in FIG. 9B differs from the triple mode resonator shown in FIG. 8A in that the T-shaped non-grounding branch 1022 in FIG. 8A is replaced with a linear non-grounding branch without a vertical portion.

The triple mode resonator shown in FIG. 9C differs from the triple mode resonator shown in FIG. 9B in that the main body portions of the upper and lower non-grounding branches both have an additional part extending toward the middle non-grounding branch.

The triple mode resonator shown in FIG. 9D differs from the triple mode resonator shown in FIG. 9B in that the main body portions of the three non-grounding branches are all folded along the right edge thereof.

Other variants can be conceived of by referring to FIGS. 7A-7H. It will be understood by those skilled in the art that increasement of area of the non-grounding branches will lower the frequency of the corresponding mode, and reduction of area of the non-grounding branches can tune the frequency in the increment direction.

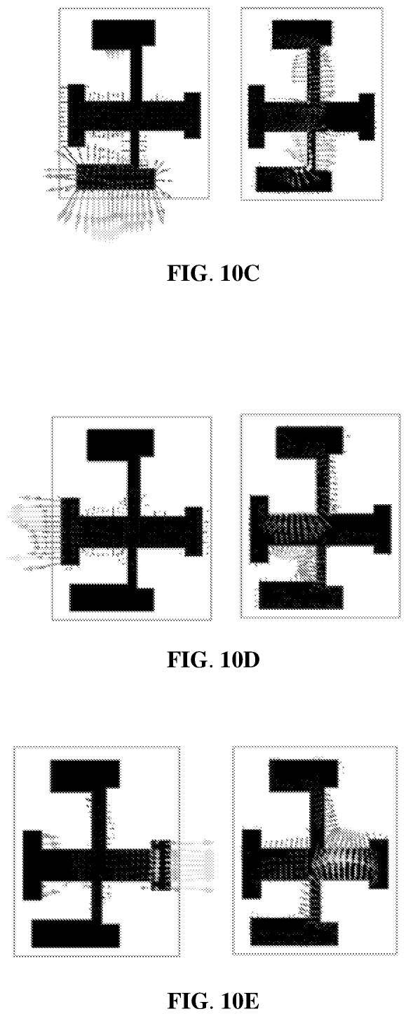

FIG. 10A shows a quadruple mode resonator in a quadruple band filter according to a fifth embodiment of the disclosure. As shown in FIG. 10A, the quadruple mode resonator is disposed in a cavity defined by a chassis, which may be made of metal or a non-metal base with a metallized surface. The quadruple mode resonator is a strip line resonator which may also be made of metal or a non-metal base with a metallized surface. The material of the quadruple mode resonator can be the same as or different from the material of the chassis. The quadruple mode resonator comprises four non-grounding branches 1031, 1032, 1033, 1034 and a grounding part 1035. The grounding part 1035 is provided at a junction of the four non-grounding branches 1031, 1032, 1033, 1034, and is connected to the chassis by soldering or welding.

In this embodiment, the four non-grounding branches 1031, 1032, 1033, 1034 extend in the same plane, and the grounding part 1035 extends in a direction perpendicular to the plane. More specifically, each of the non-grounding branches 1031, 1033 has a connection portion connected to the grounding part 1035 and a main body portion perpendicular to the connection portion, and each of the non-grounding branches 1032, 1034 has a main body portion connected to the grounding part 1035 and a tip portion perpendicular to the main body portion. The main body portions of the non-grounding branches 1031, 1032, 1033, 1034 both extend in the horizontal direction in the plane. In this connection, it can be said that the non-grounding branches 1031, 1033 extend substantially parallel to the non-grounding branches 1032, 1034. Preferably, the main body portions of the four non-grounding branches 1031, 1032, 1033, 1034 have different lengths in the horizontal direction. The four non-grounding branches 1031, 1032, 1033, 1034 may be punched out from a metal sheet and have the same thickness. However, the present disclosure is not limited to this, and the four non-grounding branches 1031, 1032, 1033, 1034 may have different thicknesses. Also, the width of the main body portions of the four non-grounding branches 1031, 1032, 1033, 1034 may be the same as or different from each other, and is greater than the width of the connection portion of the non-grounding branches 1031, 1033 and the tip portion of the non-grounding branches 1032, 1034.

FIG. 10B shows an electric field (left) and a magnetic field (right) of the quadruple mode resonator in the first mode, FIG. 10C shows an electric field (left) and a magnetic field (right) of the quadruple mode resonator in the second mode, FIG. 10D shows an electric field (left) and a magnetic field (right) of the quadruple mode resonator in the third mode, and FIG. 10E shows an electric field (left) and a magnetic field (right) of the quadruple mode resonator in the fourth mode. In this embodiment, the first mode is achieved by the whole resonator (especially the top and bottom sides of resonator), the second mode is achieved by the half bottom side of the resonator, the third mode is achieved by the left middle portion of the resonator, and the fourth mode is achieved by the right middle portion of resonator. The frequency and/or the coupling in the four modes can be tuned separately at the top side, the bottom side, the left middle side, and the right middle side of the resonator. For example, the tuning can be performed by means of a tuning screw or a tuning tab.

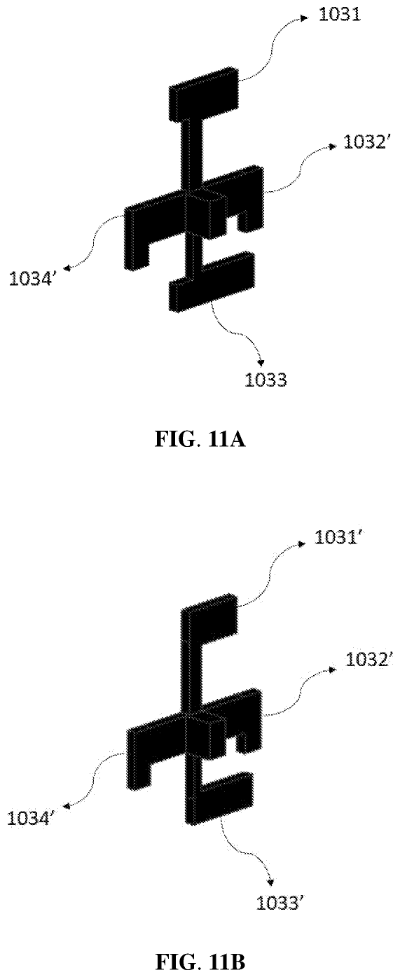

FIG. 11A and FIG. 11B show different variants of a quadruple mode resonator according to the disclosure.

The quadruple mode resonator shown in FIG. 11A differs from the quadruple mode resonator shown in FIG. 10A in that each of the non-grounding branches 1032′, 1034′ has an L-shaped cross section. The quadruple mode resonator shown in FIG. 11B differs from the quadruple mode resonator shown in FIG. 11A in that each of the non-grounding branches 1031′, 1033′ has an L-shaped cross section.

Other variants can be conceived of by referring to FIGS. 7A-7H. It will be understood by those skilled in the art that increasement of area of the non-grounding branches will lower the frequency of the corresponding mode, and reduction of area of the non-grounding branches can tune the frequency in the increment direction.

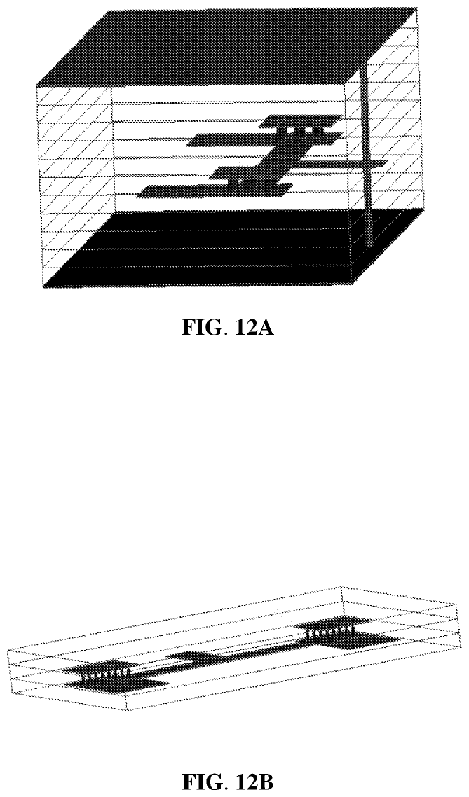

In the above embodiments, the multimode resonators are disposed in the cavity defined by the chassis. However, the present disclosure is not limited to this. For example, as shown in FIG. 12A and FIG. 12B, the multiband filter may comprise a multi-layer circuit board, and the multimode resonators may be arranged on a middle layer that is sandwiched between an upper conductive layer and a lower conductive layer, and may be surrounded by metalized vias for electrically connecting the upper conductive layer and the lower conductive layer. The upper conductive layer, the lower conductive layer and the metalized vias form the cavity of the multiband filter. Each multimode resonator may be formed on one middle layer or may be formed across two or more middle layers, and in the later case, portions of the at least one multimode resonator on different layers are connected by metalized via(s) through the layers.

In an embodiment, the middle layer is made of ceramic, and the multimode resonators are formed on the middle layer by LTCC technology or HTCC technology. In another embodiment, the multi-layer circuit board is a PCBA, and the multimode resonators are laminated on the middle layer. In a further embodiment, the multimode resonators are plated on the middle layer. In these kinds of solution, the middle grounding part of the resonator could be connected to one of the metalized vias for electrically connecting the upper conductive layer and the lower conductive layer.

While various multiband filter and multimode resonator are illustrated and described above, those skilled in the relevant art will conceive of other multiband filter comprising a plurality of multimode resonators, wherein each of the multimode resonators is a strip line resonator comprising a grounding part and two or more non-grounding branches for achieving multiple modes.

The present disclosure also relates to communication device comprising at least one multiband filter as described above, such as a radio unit or an antenna unit. The multiband filter may be soldered on a radio board or an antenna board, or may be connected to the radio board or the antenna board by RF connectors.

Advantages of embodiments of the present disclosure will be described below.

According to the present disclosure, the multiband filter comprises a plurality of multimode resonators, each of which is a strip line resonator comprising a grounding part and two or more non-grounding branches for achieving multiple modes. With such a configuration, it is convenient to achieve two or more modes in a strip line resonator by different area of the resonator, thereby achieving a multiband filter.

Compared with existing multiband filters in which a common cavity is provided to combine multiple filters of a single band, the radio size/weight and the cost can be reduced. In addition, the radio front end performance, such as harmonic and insertion loss, is improved compared with multiband CWG filters. Moreover, the multiband filter according to the present disclosure has better reliability and robustness.

The multimode resonators can be produced separately and soldered on a chassis, or can be produced one time (i.e., integrally) with the chassis together.

The multimode resonators can also be formed on a middle layer of a multi-layer circuit board, for example, by LTCC or HTCC technology, by lamination on PCB, or by plating on ceramic.

The frequency and/or the coupling in different modes can be tuned separately in production, for example, by means of a tuning screw or a tuning tab.

To get better out of band attenuation, a metal strip line LPF can be added at an input area or an output area of the multiband filter.

To further reduce the filter size, plastic material can be added on at least one side of the strip line resonator.

The multiband filter may have multiple RF ports and can couple with single mode resonator based on different requirement, which is flexible.

The multiband filter according to the present disclosure can be soldered on a PCB, such as a radio board or an antenna board, or can be connected to other radio components by RF connectors. This provides a flexible assembling solution for the filter, as well as high level building practice solution.

References in the present disclosure to “an embodiment”, “another embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A multiband filter, comprising a plurality of multimode resonators, wherein each of the multimode resonators is a strip line resonator comprising a grounding part and two or more non-grounding branches for achieving multiple modes.

2. The multiband filter according to claim 1, further comprising a chassis that defines a cavity, wherein the multimode resonators are disposed in the cavity, and the grounding part is connected to the chassis.

3. The multiband filter according to claim 2, wherein the multimode resonators are integrally part of the chassis.

4. The multiband filter according to claim 2, wherein the multimode resonators are connected to the chassis by soldering or welding.

5. The multiband filter according to claim 2, wherein the chassis and/or the strip line resonator is/are metal or a non-metal base with a metallized surface.

6. The multiband filter according to claim 1, further comprising a multi-layer circuit board, wherein the multimode resonators are arranged on a middle layer that is sandwiched between an upper conductive layer and a lower conductive layer, and are surrounded by metalized vias for electrically connecting the upper conductive layer and the lower conductive layer.

7. The multiband filter according to claim 6, wherein the grounding part of each of the multimode resonators is connected to one of the metalized vias

8. The multiband filter according to claim 6, wherein the middle layer is made of ceramic, and the multimode resonators are formed on the middle layer by LTCC (Low Temperature Co-fired Ceramic) technology or HTCC (High Temperature Co-fired Ceramic) technology.

9. The multiband filter according to claim 6, wherein the multi-layer circuit board is a PCBA (Printed Circuit Board Assembly), and the multimode resonators are laminated on the middle layer.

10. The multiband filter according to claim 6, wherein at least one multimode resonator extends across two or more middle layers, and portions of the at least one multimode resonator on different layers are connected by a metalized via through the two or more layers.

11. The multiband filter according to claim 1, wherein a first one of the plurality of multimode resonators is connected to a first RF (Radio Frequency) port, and a second one of the plurality of multimode resonators is connected to a second RF port.

12. The multiband filter according to claim 1, wherein a first one of the plurality of multimode resonators is connected to a first RF (Radio Frequency) port, and a second one of the plurality of multimode resonators is coupled to multiple single mode resonators, each single mode resonator being connected to a corresponding one of multiple second RF ports.

13. The multiband filter according to claim 1, wherein the multiband filter is configured to be tuned in production by a tuning screw or a tuning tab.

14. The multiband filter according to claim 13, wherein the multiband filter is configured to separately tune the frequency and/or the coupling in different modes.

15. The multiband filter according to claim 1, wherein the non-grounding branches of the strip line resonator substantially extend in the same plane.

16. The multiband filter according to claim 15, wherein at least one of the non-grounding branches is folded and/or provided with an enlarged end portion.

17. The multiband filter according to claim 15, wherein at least one of the non-grounding branches contains a hole or a recess.

18. The multiband filter according to claim 15, wherein at least two non-grounding branches of the strip line resonator extend substantially parallel to each other and have different lengths in the extending direction.

19. The multiband filter according to claim 1, wherein the grounding part of the strip line resonator is provided at a junction of the two or more non-grounding branches.

20.-21. (canceled)

22. A communication device, comprising at least one multiband filter according to claim 1.

23. (canceled)
